(19) United States
(12) Patent Application Publication
(10) Pub. No.: US 2025/0136442 A1
(43) Pub. Date: May 1, 2025

(54) PLANT AND PROCESS FOR PRODUCING HYDROGEN FROM SCISSION OF METHANE MOLECULES

(71) Applicant: IDROGENA SRL, MARRUBIU (IT)

(72) Inventors: Luca TAGLIASACCHI, QUARTU SANT ELENA (IT); Federico MELONI, ORISTANO (IT); Tullia ZUCCA, COMAZZO (IT); Donato BOCCHETTI, ROMA (IT)

(21) Appl. No.: 18/692,159

(22) PCT Filed: Sep. 12, 2022
(86) PCT No.: PCT/IB2022/058560

§ 371 Date: Mar. 14, 2024

(30) Foreign Application Priority Data
Sep. 14, 2021 (IT) 102021000023708

(51) Int. Cl. C01B 3/24; B01J 6/00; C09C 1/52

(52) U.S. Cl. CPC C01B 3/24; B01J 6/008; C09C 1/52; C01B 2203/0272; C01B 2203/0855; C01B 2203/1241

(57) ABSTRACT

A plant for producing hydrogen from scission of methane molecules with production of carbon dust includes a reactor having an inner chamber delimited by a holding wall. The reactor includes an inlet opening for feeding methane (CH4), an outlet opening for allowing hydrogen (H2) in gaseous form to flow out. A discharge opening is for discharging carbon dust (C) from the inner chamber through a sealing rotary valve. A refractory lining, and an electromagnetic induction heater are for heating the inner chamber of the reactor.

### TECHNICAL FIELD

The present invention relates to a plant for producing hydrogen H₂ from direct scission of methane molecules CH₄ with production of carbon dust C.

According to a further aspect thereof, the present invention also relates to a process for producing hydrogen H₂ from direct scission of methane molecules CH₄ with production of carbon dust C.

### TECHNICAL BACKGROUND

Nowadays there is an ever increasing demand for hydrogen for several uses, e.g. for producing chemical compounds, for use as fuel for motor vehicles, or for producing heat and electric energy.

The requirement that needs to be met is the ability of producing hydrogen by using plants and processes having a low environmental impact, particularly without producing carbon dioxide CO₂ and without using any chemical processes or other processes that require or produce polluting by-products which then need to be properly disposed of. Furthermore, it must be taken into account that, in the industry of oil extraction from oil fields, it is often necessary to face the problem of the presence and disposal of hydrocarbon gas, particularly methane gas that must not be released into the atmosphere, so much so that it is frequently burned at the well head. It is evident that, although such methane gas cannot be conveyed into a methane pipeline because the volumes thereof in oil fields are very small, it is nevertheless an available resource that should be exploited, of course without polluting the environment. In light of the above, it is clear that there is an increasing demand for “green” hydrogen production, i.e. for hydrogen produced without polluting the environment, possibly using natural resources that would otherwise be lost and that should be appropriately disposed of.

### SUMMARY OF THE INVENTION

The problem at the basis of the present invention is to conceive a plant for hydrogen production whose structural and functional characteristics are such as to fulfil the aforesaid requirements, while at the same time overcoming the above-mentioned problems suffered by the prior art.

This problem is solved through a plant for producing hydrogen H₂ from scission of methane molecules CH₄ with production of carbon dust C as claimed in claim 1.

According to a further aspect, such problem is solved also through a process for producing hydrogen H₂ from scission of methane molecules CH₄ with production of carbon dust C as claimed in claim 9.

### BRIEF DESCRIPTION OF THE DRAWINGS

Further features and the advantages of the present invention will become apparent in light of the following description of a plant for producing hydrogen H₂ from direct scission of methane molecules CH₄ with production of carbon dust c, provided herein merely by way of non-limiting example with reference to the annexed drawings, wherein:

FIG. 1 is a simplified and schematic plan view of a plant according to the invention, and

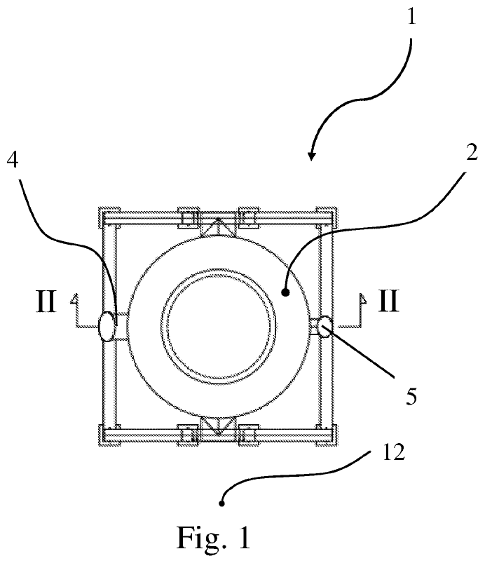

FIG. 2 is a cross-sectional view along line II-II of FIG. 1.

### DETAILED DESCRIPTION OF THE INVENTION

With reference to the annexed drawings, 1 designates as a whole a plant for producing hydrogen from scission of methane molecules with production of carbon dust C.

In particular, this is a plant capable of producing hydrogen H₂ in gaseous form from direct scission of methane molecules CH₄ with production of carbon dust C.

Plant 1 according to the invention exploits the chemical scission reaction of methane, which occurs when methane is heated to temperatures in the range of 1, 600-1,700° C. To this end, plant 1 comprises a reactor 2 having an inner chamber 3.

Such inner chamber 3 extends along a prevailing longitudinal direction X-X between a lower end 2a and an upper end 2b, and is delimited by a first holding wall 8.

Reactor 2 comprises:
an inlet opening 4 for feeding methane CHA into said inner chamber 3;
an outlet opening 5 for allowing hydrogen H₂ to flow out in gaseous form from said inner chamber 3;
a discharge opening 6 for discharging carbon dust C from said inner chamber 3, and
sealing valve means 7 applied to said discharge opening 6 for only allowing the discharge of carbon dust from said discharge opening 6 while ensuring a pressure-tight seal of said inner chamber 3 of said reactor.

It must be pointed out that said sealing valve means 7 only allow carbon dust C generated by the methane molecules' scission reaction to be discharged from inner chamber 3, still ensuring a pressure-tight seal of discharge opening 6 while however letting out the carbon dust.

According to the embodiment illustrated herein, said sealing valve means applied to discharge opening 6 comprise a sealed rotary valve 7. Alternatively, other structurally and/or functionally equivalent means may be employed, such as, for example, a sliding gate discharger or a double pivot discharger, or the like.

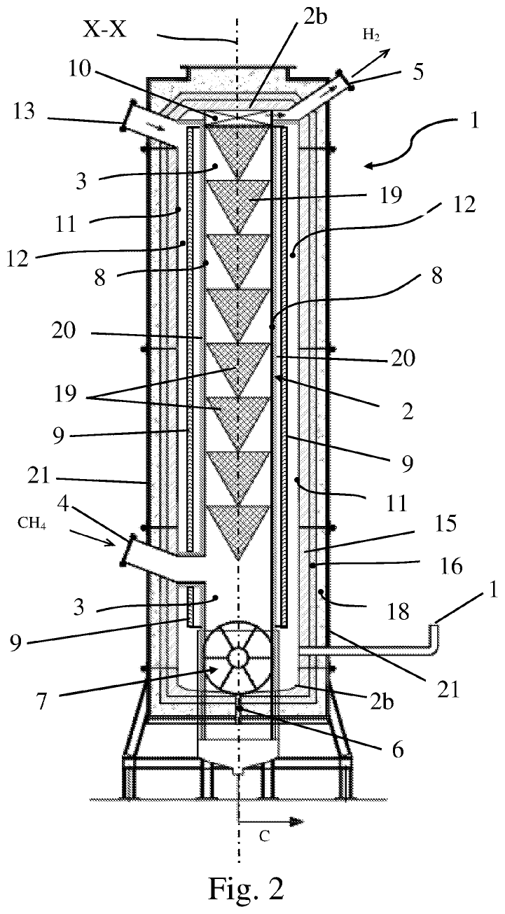

Preferably, as shown in FIG. 2, said sealing valve means 7 applied to discharge opening 6 are located at lower end 2a of inner chamber 3, so that they can be fed by gravity with carbon dust resulting from the resolution of the methane molecule into carbon and hydrogen within said chamber, thus avoiding the use of a system for conveying, e.g. by ventilation, carbon dust C toward discharge opening 6.

Reactor 2 further comprises:
a refractory lining 20 applied to said first holding wall 8, preferably applied to the outer side of the first holding wall 8, for thermally insulating inner chamber 3 from the outside environment, and
heating means 9 for heating inner chamber 3 of reactor 2 to a temperature ranging from about 600° C. to 1,700° C., or even to 1,800° C.

In order to withstand operating temperatures in the range of 600° C. to 1, 800° C., said first holding wall 8 is made of a metal material suitable for operating at such operating temperatures, e.g. tungsten (or a tungsten-based alloy), which can safely operate at temperatures as high as 2,500° C. and beyond.

Preferably, said openings are arranged in reactor 2 as follows:
said outlet opening 5 for allowing hydrogen outflow is located at or near said upper end 2b of said reactor 2, so as to permit a natural upward outflow of the hydrogen in gaseous form produced in inner chamber 3;
said discharge opening 6 for discharging carbon dust is located at or near said lower end 2a of said reactor 2, and
said inlet opening 4 for feeding methane into said inner chamber 3 is located between said outlet opening 5 for allowing hydrogen outflow and said discharge opening 6 for discharging carbon dust.

In one possible embodiment, said inlet opening 4 for feeding methane into said inner chamber 3 is located near said discharge opening 6, just above it, or said inlet opening 4 for feeding methane into said inner chamber 3 is located near said outlet opening 5, just below it.

Preferably, said inlet opening 4 for feeding methane into said inner chamber 3 is so oriented as to cause methane to be tangentially introduced into said inner chamber 3, resulting in a peripheral cyclonic swirl of methane within inner chamber 3.

Said heating means 9 for heating inner chamber 3 of said reactor 2 are located outside reactor 2, thus not being subjected to the thermal stresses caused by the high working temperatures of inner chamber 3 during the normal operation of plant 1.

Furthermore, said heating means for heating inner chamber 3 are electromagnetic induction heating means 9 suitable for generating an alternating electromagnetic field along the longitudinal axis X-X of said inner chamber 3 of said reactor 2 for heating said inner chamber 3.

Said first holding wall 8 is made of a metal material that is sensitive to the electromagnetic field, so that it can be heated also by electromagnetic induction.

Preferably, said electromagnetic induction heating means comprise:
a coil 9 (shown in schematic form in FIG. 2) made of electrically conductive material, with turns helically wound around inner chamber 3 of reactor 2, and
electric means (not shown) for causing an alternating current of predetermined amperage to circulate in the turns of said electric coil,
   so as to induce the formation of an alternating electromagnetic field within inner chamber 3, preferably an alternating electromagnetic field passing through the longitudinal axis X-X of reactor 2, such as to heat up of the inside of inner chamber 3.

Preferably, electromagnetic induction heating means 9 are located outside said refractory lining 20 and, in order to prevent any interference or shielding, refractory lining 20 is made of an electromagnetic field-transparent/permeable refractory material, e.g. a refractory material with no ferromagnetic metal impurities.

Preferably, said plant 1 comprises a second holding wall 11 that defines, together with said first holding wall 8, a sealed holding gap 12 in which said electromagnetic induction heating means 9 are advantageously housed.

Said second holding wall 11 is, for example, also made of a material suitable for safely operating at temperatures up to 2,500° C.

Preferably, said sealed gap 12 is filled with an inert gas, preferably argon.

Preferably, said sealed gap 12 is equipped with a gas inlet nozzle 13 closed by sealing valve means.

Preferably, said gas inlet nozzle 13 is placed at curtain end 2b of inner chamber 3, and sealed gap 12 comprises a further vent opening 14 located near opposite end 2a of inner chamber 3 closed by respective sealing valve means (not shown).

In accordance with the exemplary and non-limiting embodiment illustrated herein (see FIG. 2), reactor 2 comprises an outer cladding applied to the second holding wall 11 and comprising, from inside to outside:
a second layer of refractory material 15;
protective jacket 16 made of metal material, preferably steel, suitable for operating at operating temperatures around 1,250° C.;
an insulating layer 18, and
preferably, a steel sheet casing 21.

Preferably, said reactor 2 also comprises metal elements 19 supported along longitudinal axis X-X of inner chamber 3 and made of a metal material suitable for operating at operating temperatures ranging from about 600° C. to 1,800° C., said metal elements being intended to be heated in order to even out the temperature inside said chamber, thereby reducing the formation of undesired thermal gradients.

Preferably, said metal elements 19 are in contact with said first holding wall 8, thereby forming heat bridges to facilitate heat conduction toward said first holding wall 8 from the longitudinal axis of chamber 3.

Said metal elements 19 are made of a metal material that is sensitive to the electromagnetic field, so that they can be heated by electromagnetic induction.

Preferably, said metal elements 19 define grid baskets, preferably grid baskets having a conical shape extending along said axial direction X-X, with decreasing conicity toward lower end 2a.

Such baskets permit supporting, within inner chamber 3, accelerator and/or catalyst substances that may be used in order to allow the methane molecule to resolve into hydrogen and carbon dust even at temperatures below 1,500° C., e.g. starting from 600° C.

Said accelerator and/or catalyst substances carried by said baskets 19 define a floating fluid bed which is crossed by methane and hydrogen.

The material of said metal elements 19 is also a metal material that is sensitive to the electromagnetic field and suitable for operating at operating temperatures ranging from 600° C. to 1,800° C., e.g. tungsten.

Preferably, in plant 1 said outlet opening 5 allowing the outflow of hydrogen in gaseous form is in fluidic communication with said inner chamber 3 through the interposition of filtering means and/or demisters 10.

According to a further aspect, a process is provided for producing hydrogen from scission of methane molecules with production of carbon dust in a plant, comprising a reactor, according to the present invention, comprising the steps of:
providing a cylindrical reactor 2 having an inner chamber 3 delimited by a first metal holding wall 8 insulated from the outside by refractory material and equipped with an inlet opening 4 through which methane is fed, an outlet opening 5 through which hydrogen in gaseous form can flow out, and a discharge opening 6 through which only carbon dust can be discharged from said inner chamber 3;
heating said inner chamber of said reactor 2 to a temperature ranging from about 600° C. to 1,700° C., and
introducing a flow of methane gas into said inner chamber 3, so as to obtain hydrogen production from scission of methane molecules, wherein hydrogen is evacuated from an upper end of said reactor 2 through said outlet opening 5 and carbon dust precipitated toward a lower end of said inner chamber 3 is discharged through said discharge opening 6.

According to said process of the invention, said step of heating the inner chamber of reactor 2 is carried out by subjecting inner chamber 3 to electromagnetic induction from the outside, and the refractory material that insulates inner chamber 3 of reactor 2 is transparent/permeable to the electromagnetic field.

Preferably, according to said process of the invention, said heating of inner chamber 3 by electromagnetic induction from the outside is carried out by causing an alternating current to circulate in a coil of electrically conductive material with turns helically wound around the outside of said reactor 2, preferably with turns helically wound around the outside of said refractory material that insulates said inner chamber 3 of said reactor 2.

Preferably, according to said process of the invention, said coil made of electrically conductive material is housed in a sealed gap 12 defined between said first holding wall 8 and said second holding metal wall 11, said sealed gap 12 being filled with an inert gas, preferably argon.

Preferably, according to said process of the invention, inner chamber 3 is heated to a temperature of at least 1,500° C., preferably to a temperature of at least 1, 600° C., more preferably to a temperature of approximately 1,700° C., to obtain direct scission of methane molecules into hydrogen and carbon dust.

According to said process of the invention, in one possible implementation thereof:
said inner chamber 3 is heated to a temperature ranging from about 600° C. to 1,500° C., and
accelerator and/or catalyst substances are provided in said inner chamber 3 to allow methane molecules to resolve into hydrogen and carbon dust even at temperatures starting from 600° C.

Preferably, according to the process of the invention, hydrogen production from scission of methane molecules takes place in said reactor with at least 6% overpressure, preferably at least 10% overpressure, with respect to the pressure outside said reactor 2.

The above mentioned process according to the invention is carried out by means of above-described plant 1.

As can be appreciated from the above description, the plant according to the invention and the process according to the invention make it possible to meet the above-mentioned requirements while at the same time overcoming the drawbacks suffered by the prior art and summarized in the introductory part of the present description.

As a matter of fact, the reactor according to the invention has a simple and safe structure capable of ensuring that hydrogen is produced from scission of methane molecules, with production of carbon dust, in a simple and effective manner, without producing any polluting by-products to be disposed of.

It must be pointed out that, when hydrogen production occurs at reactor operating temperatures in excess of 1,500° C., e.g. temperatures in the range of 1,600-1,700° C., it is not even necessary to employ any accelerator and/or catalyst substances to achieve a direct scission of methane molecules, while below such temperatures it is advantageous to use such accelerator and/or catalyst substances to ensure a correct resolution of the methane molecule starting from a temperature of 600° C.

It should also be highlighted that temperatures of 1, 600-1,700° C. will give highly pure hydrogen, e.g. hydrogen already suitable for motor vehicles, as well as highly pure carbon dust, which can be used in the pharmaceutical industry for making filters, etc.

Furthermore, the carbon dust can be burned with little oxygen to give highly pure carbon monoxide.

It should also be highlighted that the heating of the inner chamber by induction from outside the reactor is very effective, since it is confined in the inner chamber, which is thermally shielded from the outside through said electromagnetic field-transparent refractory material.

Furthermore, said sealed gap containing argon significantly improves the safety of the plant, even in the presence of hydrogen, in case of cracks or leaks in the reactor, particularly even before a fault indication is triggered by the safety sensors.

Of course, those skilled in the art may, in order to fulfil contingent and specific requirements, subject the above-described invention to many modifications and variations, all of which will nevertheless still fall within the protection scope of the invention as set out in the following claims.

1. A plant for producing hydrogen (H2) from scission of methane molecules (CH4) with production of carbon dust (C), comprising a reactor having an inner chamber extending in a prevailing longitudinal direction between a lower end and an upper end and delimited by a first holding wall, wherein said reactor comprises:
an inlet opening for feeding methane (CH4) into said inner chamber;
an outlet opening for allowing hydrogen (H2) to flow out in gaseous form from said inner chamber:
a discharge opening for discharging carbon dust (C) from said inner chamber;
a sealing valve applied to said discharge opening for only allowing the discharge of carbon dust (C) from said discharge opening while ensuring a pressure-tight seal of said inner chamber in said reactor, and
a refractory lining applied to said first holding wall for thermally insulating said inner chamber from the outside, wherein:
said plant comprises a heater for heating the inner chamber of said reactor to a temperature ranging from about 600° C. to 1,700° C., wherein said heater is located outside said reactor,
said first holding wall is made of a metal material, for operating at operating temperatures ranging from about 600° C. to 1,800° C.: wherein:
said heater for heating the inner chamber of said reactor is an electromagnetic induction heater for generating an alternating electromagnetic field along the longitudinal axis of said inner chamber of said reactor for heating said inner chamber; and
said first holding wall is made of a metal material that is sensitive to the electromagnetic field, so that said first holding wall is heatable by electromagnetic induction.

2. The plant according to claim 1, wherein:
said outlet opening for allowing hydrogen outflow is located at or proximate said upper end of said reactor;
said discharge opening for discharging carbon dust is located at or proximate said lower end of said reactor, and
said inlet opening for feeding methane into said inner chamber is located between said outlet opening for allowing hydrogen outflow and said discharge opening for discharging carbon dust.

3. The plant according to claim 1, wherein said sealing valve applied to said discharge opening comprises a rotary valve, a sliding gate discharger or a double pivot discharger, said sealing valve being fed by gravity with carbon dust resulting from the methane molecules decomposing into carbon and hydrogen within said inner chamber.

4. The plant according to claim 1, wherein said electromagnetic induction heater comprises:
a coil made of electrically conductive material, with turns helically wound around said reactor, and
electric means for causing an alternating current of predetermined amperage to circulate in the windings of said electric coil, to induce formation of an alternating electromagnetic field in said inner chamber of said reactor, along the axis of said reactor, to cause heating inside said inner chamber.

5. The plant according to claim 1, wherein:
said refractory lining applied to said first holding wall is made of an electromagnetic field-transparent/permeable refractory material, and
said electromagnetic induction heater is placed outside said refractory lining.

6. The plant according to claim 5, comprising a second holding wall that defines a sealed holding gap with said first holding wall, wherein said electromagnetic induction heater is housed in said sealed gap: wherein said sealed gap is filled with an inert gas, said sealed gap being equipped with a gas inlet nozzle closed by a nozzle sealing valve, said gas inlet nozzle is placed at one end of said inner chamber, and said gap comprises a further vent opening located proximate a opposite end of said inner chamber and closed by respective vent sealing valves.

7. The plant according to claim 1, wherein said reactor comprises metal elements supported along the longitudinal axis of said inner chamber and made of a metal material, for operating at operating temperatures ranging from about 600° C. to 1,800° C., said metal elements being for heating to even out the temperature inside said chamber: wherein said metal elements are in contact with said first holding wall, thereby forming heat bridges to facilitate heat conduction toward said first holding wall and to reduce a temperature gradient in said inner chamber; wherein said metal elements are made of a metal material that is sensitive to the electromagnetic field, so that said metal elements are heatable by electromagnetic induction.

8. The plant according to claim 1, wherein said inlet opening for feeding methane into said inner chamber is oriented to cause methane to be tangentially introduced into said inner chamber.

9. A process for producing hydrogen (H2) from scission of methane molecules (CH4) with production of carbon dust (C) in a plant, comprising reactor, according to claim 1, comprising the steps of:
providing the reactor comprising a cylindrical reactor having the inner chamber delimited by the first metal holding wall insulated from the outside by refractory material and equipped with the inlet opening through which methane is fed, the outlet opening through which hydrogen in gaseous form can flow out, and the discharge opening through which only carbon dust is dischargeable from said inner chamber;
heating said inner chamber of said reactor to a temperature ranging from about 600° C. to 1,700° C., and
introducing a flow of methane gas into said inner chamber, to obtain hydrogen production from scission of methane molecules, wherein hydrogen is evacuated from the upper end of said reactor through said outlet opening and carbon dust precipitated toward the lower end of said inner chamber is discharged through said discharge opening.

10. The process according to claim 9, wherein said inner chamber is heated to a temperature of at least 1,500° C. to obtain direct scission of methane molecules into hydrogen and carbon dust.

11. The process according to claim 9, wherein said hydrogen production from scission of methane molecules takes place in said reactor with at least 6% overpressure, with respect to pressure outside said reactor.

12. The process according to claim 9, wherein said inner chamber is heated to a temperature of at least 1600° C., to obtain direct scission of methane molecules into hydrogen and carbon dust.

13. The process according to claim 9, wherein said inner chamber is heated to a temperature of at least 1700° C., to obtain direct scission of methane molecules into hydrogen and carbon dust.

14. The process according to claim 9, wherein said hydrogen production from scission of methane molecules takes place in said reactor with at least 10% overpressure, with respect to pressure outside said reactor.

15. The plant according to claim 1, wherein said first holding wall is made of tungsten or alloys.
